(19) United States
(12) Patent Application Publication
(10) Pub. No.: US 2009/0243501 A1
(43) Pub. Date: Oct. 1, 2009

(54) COMBINED SERIAL/PARALLEL LIGHT CONFIGURATION

(75) Inventors: William DUNN, Alpharetta, GA (US); David Williams, Canton, GA (US)

Correspondence Address: STANDLEY LAW GROUP LLP, 6300 Riverside Drive, Dublin, OH, 43017, US

(73) Assignee: MANUFACTURING RESOURCES INTERNATIONAL, INC., Alpharetta, GA (US)

(21) Appl. No.: 12/235,232

(22) Filed: Sep. 22, 2008

Related U.S. Application Data
(60) Provisional application No. 61/061,032, filed on Jun. 12, 2008.
(60) Provisional application No. 61/039,454, filed on Mar. 26, 2008.

(51) Int. Cl. H05B 41/14

(52) U.S. Cl. 315/192

(57) ABSTRACT

Exemplary embodiments connect lights in both series and parallel. The lights can be LEDs, organic light emitting diodes (OLED), field emitting display (FED), light emitting polymer (LEP), or organic electro-luminescence (OEL). Exemplary embodiments also mount the lights on a printed circuit board (PCB) which has low thermal resistivity between the surface containing the lights and the opposite surface. The opposite surface may be metallic, and air may be forced over this surface in order to cool the assembly.

### CROSS-REFERENCE TO RELATED APPLICATIONS

This application is a non-provisional patent application claims priority to U.S. Provisional Application Nos. 61/061,032 filed Jun. 12, 2008 and 61/039,454 filed Mar. 26, 2008 and are herein incorporated by reference in their entirety.

### TECHNICAL FIELD

Exemplary embodiments relate generally to a circuit configuration for illumination devices and more specifically to a series and parallel configuration of LED lights. Embodiments also relate to printed circuit boards containing the circuit configuration and dissipating heat from the illumination devices to the surrounding air.

### BACKGROUND OF THE ART

In various lighting applications, a plurality of concerns have prompted the lighting industry to begin utilizing light emitting diodes (LEDs) for providing the illumination source. Typically, these LEDs are connected in series. However, when a single LED fails, current will no longer pass through the LEDs and their illumination will cease.

### SUMMARY OF THE INVENTION

Exemplary embodiments connect LEDs in both series and parallel. This connection allows current to flow around an LED that has failed, so that the remaining lights in the assembly may continue to provide illumination. Embodiments can utilize not only LEDs, but also organic light emitting diodes (OLED), field emitting display (FED), light emitting polymer (LEP), and organic electro-luminescence (OEL).

Exemplary embodiments also mount the LEDs on a printed circuit board (PCB) which has low thermal resistivity between the surface containing the LEDs and the opposite surface. The opposite surface may be metallic, and air may be forced over this surface in order to cool the assembly.

### BRIEF DESCRIPTION OF THE DRAWINGS

A better understanding of the exemplary embodiments will be had when reference is made to the accompanying drawings, wherein identical parts are identified with identical reference numerals, and wherein:

FIG. 1 is a schematic circuit diagram of an exemplary embodiment.

### DETAILED DESCRIPTION OF A PREFERRED EMBODIMENT

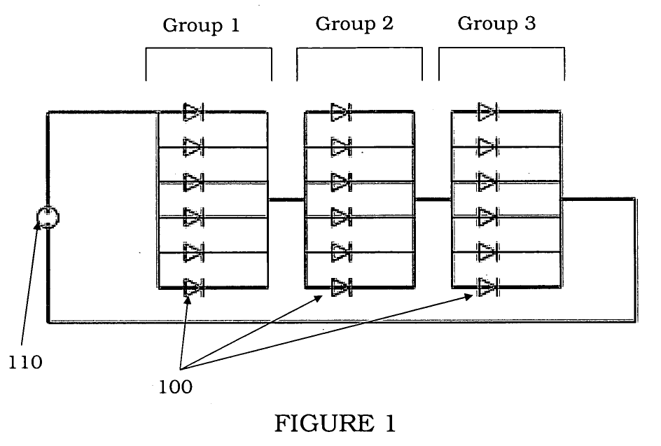

Turning to the drawings for a better understanding, FIG. 1 shows a plurality of lights 100 which are electrically connected to a power source 110 in both series and parallel. In this embodiment, six lights are wired into each of parallel Groups 1 through 3. Each parallel group is then wired in series with one another. Thus, if any one of the lights 100 were to fail, current may pass through any of the other lights within the parallel group, and subsequently through the remaining groups in the series connection.

It should be noted, that embodiments may contain more or less than six lights in each of the parallel groups. It should also be noted, that embodiments may contain more or less than three parallel groups in series. Furthermore, the circuitry may contain additional elements such as amplifiers, limiters, microprocessors, resistors, capacitors, and measurement devices to further improve the performance of the circuit.

The lights and the circuitry may be a portion of a printed circuit board (PCB). The PCB may comprise a standard FR4 circuit board. An exemplary embodiment may utilize a low level of thermal resistance between the lights and the rear surface of the PCB. This allows heat to dissipate from the lights to the rear of the PCB where it may be removed from the lighting assembly by convection or conduction or both. An exemplary embodiment may use a metal core PCB for this purpose. The PCB for an exemplary embodiment may contain a metallic rear PCB surface where cooler air may pass over the surface and remove heat from the lighting assembly. The rear surface of the PCB may be comprised of aluminum. The surface of the PCB which contains the lights may be coated with a highly reflective coating and may also be of a specific color, depending on the specific requirements for the lighting application.

Embodiments can be utilized for any variety of illumination applications, including but not limited to: backlighting for electronic displays, architectural lighting, advertisement lighting, effect lighting, or backlighting for static displays. Embodiments may utilize any one of the following: LEDs, organic light emitting diodes (OLED), field emitting display (FED), light emitting polymer (LEP), and organic electro-luminescence (OEL).

Having shown and described preferred embodiments, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

What is claimed is:

1. An illumination circuit comprising:
a power source;
a first group of lights comprising two or more lights connected in parallel;
a positive conduction line connected to said power source and to said first group of lights;
a second group of lights comprising two or more lights connected in parallel, wherein said second group of lights is connected in series to said first group of lights; and
a negative conduction line connected to said second group of lights and returning to said power source.

2. The illumination circuit from claim 1 further comprising:
a third group of lights comprising two or more lights connected in parallel; and
wherein said third group of lights is connected in series to said second group of lights and to said negative conduction line returning to said power source.

3. The illumination circuit from claim 2 wherein said lights are LEDs.

4. The illumination circuit from claim 2 wherein said lights are any one of the following: organic light emitting diodes (OLED), field emitting display (FED), light emitting polymer (LEP), and organic electro-luminescence (OEL).

5. The illumination circuit from claim 1 wherein said lights and conduction lines are attached to a printed circuit board (PCB).

6. The illumination circuit from claim 5 wherein said PCB is a metal core PCB.

7. The illumination circuit from claim 6 wherein the rear surface of the metal core PCB is metallic.

8. An illumination assembly comprising:
a metal core printed circuit board (PCB) comprising front and rear surfaces;
a first group of lights mounted on the front surface of said PCB, said first group of lights comprising two or more lights connected in parallel;
a second group of lights mounted on said front surface of said PCB, said second group of lights comprising two or more lights connected in parallel, wherein said second group of lights is connected in series to said first group of lights;
a power source;
a positive conduction line connected to said power source and to said first group of lights; and
a negative conduction line connected to said second group of lights and returning to said power source.

9. The illumination assembly from claim 8 wherein said lights are LEDs.

10. The illumination assembly from claim 8 wherein said lights are any one of the following: organic light emitting diodes (OLED), field emitting display (FED), light emitting polymer (LEP), and organic electro-luminescence (OEL).

11. The illumination assembly from claim 8 further comprising:
a third group of lights mounted on said front surface of said PCB, said third group of lights comprising two or more lights connected in parallel, wherein said third group of lights is connected in series to said second group of lights and to said negative conduction line returning to said power source.

12. The illumination assembly from claim 11 wherein said PCB has a low thermal resistivity between the front and rear surfaces.

13. The illumination assembly from claim 12 wherein air is forced over the rear surface of the PCB.

14. The illumination assembly from claim 13 wherein the rear surface of the PCB is metallic.

15. An illumination assembly comprising:
a metal core printed circuit board (PCB) comprising front and rear surfaces, wherein said rear surface is metallic and said front surface is highly reflective;
a first group of LEDs mounted on the front surface of said PCB, said first group of LEDs comprising two or more LEDs connected in parallel;
a second group of LEDs mounted on said front surface of said PCB, said second group of LEDs comprising two or more LEDs connected in parallel, wherein said second group of LEDs is connected in series to said first group of LEDs;
a power source;
a positive conduction line connected to said power source and to said first group of LEDs; and
a negative conduction line connected to said second group of LEDs and returning to said power source.

16. The illumination assembly from claim 15 further comprising:
a third group of LEDs mounted on said front surface of said PCB, said third group of LEDs comprising two or more LEDs connected in parallel, wherein said third group of LEDs is connected in series to said second group of LEDs and also to said negative conduction line returning to said power source.

17. The illumination assembly from claim 16 wherein said rear surface of said PCB is aluminum.

18. The illumination assembly from claim 16 wherein air is forced over the rear surface of said PCB.

19. The illumination assembly from claim 16 wherein said front surface of said PCB is white.

20. The illumination assembly from claim 16 wherein said connections are comprised of copper.
